(19) United States
(12) Patent Application Publication
(10) Pub. No.: US 2003/0006886 A1
(43) Pub. Date: Jan. 9, 2003

(54) System for disabling vehicles having air brake systems

(76) Inventor: Charles H. Gabbard, Laguna Hills, CA (US)

Correspondence Address: STETINA BRUNDA GARRED & BRUCKER, 75 ENTERPRISE, SUITE 250, ALISO VIEJO, CA, 92656, US

(21) Appl. No.: 10/127,932

(22) Filed: Apr. 23, 2002

Related U.S. Application Data
(63) Continuation-in-part of application No. 09/517,892, filed on Mar. 3, 2000, now Pat. No. 6,411,217.
Application No. 09/517,892 is a continuation-in-part of application No. 09/159,438, filed on Sep. 24, 1998, now Pat. No. 6,124,805.
Application No. 09/159,438 is a continuation-in-part of application No. 09/081,473, filed on May 19, 1998, now Pat. No. 6,232,884.

(51) Int. Cl. B60Q 1/00

(52) U.S. Cl. 340/425.5; 340/426; 340/438

(57) ABSTRACT

The present invention relates to a vehicle disabling system for terminating operation of a vehicle having a braking system thereon. The system includes a transmit unit transmitting at least one brake activation message to the vehicle. The system may further include a vehicle unit in communication with at least one braking component of the braking system such that receipt of the at least one brake activation message causes the vehicle unit to activate the at least one braking component thereby reducing speed of the vehicle and preventing movement thereof. Further, operator identity may be confirmed via use of a biometrics identification reader. A global positioning satellite may be employed for storing a usage record of the transmit unit.

### CROSS-REFERENCE TO RELATED APPLICATIONS

This Application is a continuation-in-part application of co-pending U.S. patent application Ser. No. 09/517,892, filed Mar. 3, 2000, which is a continuation-in-part application of U.S. patent application Ser. No. 09/159,438, filed Sep. 24, 1998, issued Sep. 26, 2000 as U.S. Pat. No. 6,124,805, which is a continuation-in-part application of U.S. patent application Ser. No. 09/081,473, filed May 19, 1998, issued May 15, 2001 as U.S. Pat. No. 6,232,884.

### STATEMENT RE: FEDERALLY SPONSORED RESEARCH/DEVELOPMENT

(Not Applicable)

### BACKGROUND OF THE INVENTION

The present invention generally relates to the field of vehicle security and more particularly to systems for disabling vehicles having air brake systems thereon.

The use of stolen vehicles in committing crimes and in escaping capture by law enforcement officials represents a major criminal activity in both urban and rural communities. Criminals may use stolen vehicles in the commission of bank, jewelry and retail store robberies, fleeing from arrest or re-arrest after an escape, a hit-and-run accident, and other illegal actions. When such an event occurs and identity of the stolen vehicle is known, police officers who spot the vehicle will give chase to hopefully apprehend the driver and any accompanying passengers. Current statistics show that there are approximately 27,000 vehicle chases in the United States everyday. Unfortunately, such police chases can result in tragic endings when innocent third parties are involved in collisions, shootings, or the like during the chase procedure.

As is expected, the longer a chase takes, the greater are the chances that non-involved parties will become victims of the pursuit. As a result, law enforcement officials may need to terminate chase efforts because of danger to third parties and thus permit criminals to escape apprehension. When such termination is not a viable choice, however, risks continue to accrue until the course of the chase is resolved. In view of the danger and potential injury to innocent third parties because of police chases, it is evident that a need is present for technology that can allow police personnel to apprehend such fleeing criminals without lengthy pursuits. Accordingly, an object of the present invention is to provide a vehicle disabling system for terminating operation of a vehicle upon transmission of a command.

While standard passenger vehicles alone may already be dangerous to the welfare of the public, large commercial vehicles pose an even greater danger. For example, thieves and other felons who gain control of such large vehicles have the capability to inflict greater damage upon properties, other vehicles and pedestrians due to the enormous size and weight of the vehicles. Additionally, trucks, tractor-trailers, and buses may require disabling in emergency situations where their emergency brakes fail or otherwise do not activate and cannot be disabled by other means. To stop such vehicles, powerful braking systems are typically employed which have sufficient power to stop heavy trucks traveling at high speeds. Usually, these braking systems are known as air brake systems which utilize air pressure instead of fluidic pressure to activate braking components. Thus, it is an object of the present invention to provide a system for disabling vehicles having braking systems, i.e. air brake systems or anti-lock braking systems, and safely reducing the speed of such vehicles so as to prevent movement thereof.

Another object of the present invention is to provide such a disabling system whereby the vehicle has a command receiver in communication with equipment capable of shutting down engine operation.

Yet another object of the present invention is to provide such a disabling system wherein fuel flow or electrical power to the vehicle engine is terminated to thereby effectuate a shut down.

Yet another object of the present invention is to provide a disabling system wherein a query, command, and command receipt are key-coded using a continuously changing key.

Yet another object of the present invention is to provide a communication link interfacing relevant vehicle theft information as well as monitored vehicle locations as transmitted by the global positioning satellite with the disabling system.

Another object of the present invention is to provide positive operator identification through biometrics wherein a data base storing previously entered biometrics identifications of respective authorized operators compares operator biometrics identification to match operator identification authorization before activating system operability.

These and other objects of the present invention will become apparent throughout the description which now follows.

### BRIEF SUMMARY OF THE INVENTION

In the context of trucks, tractor-trailers, buses and other large vehicles, the braking systems typically utilize what are known as air brake systems. Such air brake systems typically include a service brake system, a parking brake system, and an emergency brake system. The service brake systems apply and release brakes as controlled by the driver during normal driving. The parking brake system typically provides a brake for keeping the vehicle in a stationary location and preventing momentum of the same. The emergency brake system is a failsafe system whereby a detected loss in air pressure causes the emergency brake system to engage the brake system and stop the vehicle. Such systems are typically employed due to the grave danger which such large vehicles present should their brake systems fail.

It has been discovered that such air brake systems may be activated via the use of an air tank solenoid valve placed inline between the air brakes and the air tank and/or air source, i.e. air compressor. In air brake systems where constant air pressure is delivered to air brakes and a failsafe mechanism is provided for stopping the vehicle should the air pressure drop below a threshold level, the air tank solenoid valve may utilize the existing comprehensive braking system to disable such vehicles safely. Such a system is particularly useful for tractor-trailers which typically do not employ any motors or other mechanisms for gaining momentum. Should tractor trailers ever become detached from its counterpart truck or another emergency need should arise, the present system may remotely disable the tractor trailer and prevent potential injury to others. With such an extensive system for stopping vehicles already installed in many of the large vehicles on the road today, there is a need for systems which safely disables such vehicles.

Additionally, with respect to vehicles having anti-lock braking systems (ABS), the present invention may also take advantage of the existing ABS-equipped vehicles on the road today. Many vehicles are equipped with ABS to prevent the brakes from locking up in emergency conditions. Brakes which lock up typically cause a vehicle to uncontrollably slide out of control. To prevent such an occurrence, ABS utilizes speed sensors placed at a location on each wheel to monitor the rotational speed of the same. An electronic control unit monitors these sensors and when a potential loss of traction or lock up is detected, the electronic control unit sends a signal to a hydraulic control unit which modulate hydraulic valves to prevent loss of traction. Advantageously, the present invention may be formed so as to electrically communicate with the electronic control unit of the ABS existing on vehicles thereby activating the respective hydraulic valves upon receipt of a brake activation message. Ultimately, such a system allows for remote disabling of a vehicle having anti-locking braking systems.

The present invention is a vehicle disabling system for terminating operation of a vehicle. The system comprises, first of all, a transmit unit for transmitting a command shutdown message which may preferably be an infrared beam. Second, the system comprises a command-receiver vehicle unit capable of responding to the command and in communication with a transmission receiver situated at an accessible site of the vehicle such that a shutdown message from the transmit unit can reach the vehicle unit. The vehicle unit is in communication with at least one operational component of the vehicle and capable of shutting down that component upon receipt of a shutdown message from the transmit unit to thereby terminate vehicle operation The transmit unit, which is preferably a hand holdable unit, is operable only by an operator having a pre-authorized biometrics identification read at the transmit unit site, with one example of an easily obtainable biometrics identification being a thumb print. In particular, the transmit unit includes an operator biometrics identifier having access to a data base of respective authorized biometrics stored-identification indicia for a plurality of respective authorized operators. This data base preferably is stored within the transmit unit itself, but optionally can be off-site and accessible via a conventional computer linkage between the transmit unit and a remote location. The transmit unit has a reader of operator biometrics indicia as provided by the proposed operator, a comparator of operator biometrics identification indicia with the stored-identification indicia for matching the operator biometrics identification indicia with the stored-identification indicia, and a transmit unit activator for activating the transmit unit only upon a match of operator biometrics identification indicia with stored-identification indicia.

Preferably, the transmit unit initially transmits a query message prior to any shutdown message to confirm potentially accessible vehicle information or to simply confirm the presence of the vehicle disabling system. The vehicle unit is capable of receiving both the query message and the shutdown message and of responding to the query message. When the query response is an expected response, the vehicle unit can substantially immediately react to the shutdown message and accomplish shutdown of the operational component with which it is in communication. In one embodiment, the system can include database access to information about each particular -vehicle and/or vehicle owner with respect to registered ownership, insurance coverage, outstanding judicial actions, etc., etc., all accessible as a result of vehicle unit response to the transmit unit query. Such query response can range simply from the vehicle identification number which is thereafter correlated via computer link with stored vehicle information, to a programmable data base within the vehicle unit which can be remotely changed as by telephone input using the standard communication microburst system to provide a direct response.

The query message and the shutdown message of the transmit unit and the query message response of the vehicle unit preferably are encoded with a continuously changing key determined by time of day and an algorithm common to both units. Both the transmit unit and the vehicle unit preferably are in separate communication with the global positioning satellite. In particular, with respect to the transmit unit, such satellite communication functions to record all transmit unit usage and transmit this information to a monitor station to thereby maintain and assure proper and appropriate operator use of the transmit unit. With respect to the vehicle unit, such satellite communication functions to receive location information of the vehicle both for apprehension purposes and for stolen-vehicle recovery purposes. In addition to having the operational components in communication with the vehicle unit for disabling of an already-operating vehicle, the operational components can also be in communication with a keyed ignition switch of the vehicle. In that instance, conventional computer circuitry including a computer chip on the key would shut down the operational components when the key is absent to thereby provide anti-theft functionality.

In second embodiment of the invention, a vehicle disabling system for terminating operation of a vehicle having a braking system is provided. Preferably, the vehicle has an air brake system such that reduction of speed is facilitated through the use of an air tank and complimentary air brakes on the wheels of the vehicle. A transmit unit may be provided which transmits at least one brake activation message to the vehicle. Preferably, the transmit unit includes an infrared beam transmitter for sending the brake activation message and other messages such as a query message. The vehicle unit is in communication with at least one braking component of the braking system. In this respect, receipt of the brake activation message causes the vehicle unit to activate the braking component thereby reducing speed of the vehicle and preventing movement of the same. Furthermore, air brakes may be provided on locations of the vehicle for allowing the air brakes to reduce speed of the vehicle, i.e. the vehicle's rotors. Preferably, the braking component is an air tank solenoid valve which is in communication with the air brakes. optionally, the braking component may be an anti-lock braking system electrical control unit which is in communication with the hydraulic brake system of the vehicle. The air tank solenoid valve may be positionable between an activated position and a deactivated position for selectively controlling activation and deactivation of the air brakes respectively. Even more preferably, the air tank solenoid valve is in gaseous communication with each of the air brakes and an air tank having a quantity of gas stored therein. The air tank solenoid valve may activate and deactivate the air brakes by selectively restricting and allowing flow of gas from the air tank to the air brakes. Thus, the air tank solenoid valve effectively acts as an intermediary which controls the air pressure being supplied by the air tank to the air brakes. Should the vehicle unit receive at least one brake activation message, the vehicle unit will activate the air tank solenoid valve thereby activating the air brakes to reduce speed of the vehicle.

More preferably, each of the air brakes should include a spring brake as found on large commercial trucks and tractor-trailers as a safety precaution. The spring brakes should be maintained in a non-engaging position when pressurized by the air tank and should be positioned into an engaging position (to engage the respective wheels, rotors or other elements found at respective locations on the vehicle) when the vehicle unit receives at least one brake activation message. In this respect, the emergency braking features of the vehicle may be activated by the vehicle unit to reduce speed of the vehicle and prevent movement thereof.

In a third embodiment of the present invention, a vehicle disabling system for termination operation of a vehicle having an anti-lock braking system (ABS) is provided. Preferably, the vehicle has an anti-lock braking system such that reduction of speed is facilitated through use of an electronic control unit in communication with a hydraulic control unit which is controls brakes on the wheels of a vehicle. A transmit unit may be provided which transmits at least one brake activation message to the vehicle. Preferably, the transmit unit includes an infrared beam transmitter for sending the brake activation message and other messages such as a query message. The vehicle unit is in communication with at least one braking component of the braking system. Receipt of the brake activation message then causes the vehicle unit to transmit a signal to the anti-lock braking system electronic control unit which then activates the braking component thereby reducing speed of the vehicle and preventing movement of the same. In this embodiment, anti-lock brakes may be provided on locations of the vehicle for allowing the brakes to reduce the speed of the vehicle, i.e. the rotors. While it is preferred that the vehicle unit electrically communicates with the electronic control unit to facilitate reduction of vehicle speed, a hydraulic solenoid valve may also be provided which is placed in communication with the hydraulic brakes. In this respect, the vehicle unit may communicate with the hydraulic solenoid valve in response to receiving at least one brake activation message and directly activate the respective brakes. The hydraulic solenoid valve may be positionable between an activated position and a deactivated position for selectively controlling activation and deactivation fo the anti-lock brakes respectively. Even more preferably, the hydraulic solenoid valve is in fluidic communication with each of the anti-lock brakes.

As is apparent, the disabling system of the present invention provides a safe and efficient manner for law enforcement personnel to apprehend criminals attempting vehicular escape to avoid capture. The system can be incorporated in new vehicles during their production, or it can be retrofitted to vehicles now in operation. Use of the system can ensure reduced risk and danger to innocent third parties as well as to law enforcement personnel by essentially eliminating the need for vehicle chases.

### BRIEF DESCRIPTION OF THE DRAWINGS

These as well as other features of the present invention will become more apparent upon reference to the drawings wherein:

FIG. 1 is a flow diagram of a first embodiment of the vehicle disabling system for terminating operation of a vehicle; and

FIG. 2 is a flow diagram of a second embodiment of the vehicle disabling system for terminating operation of a vehicle having a braking system thereon.

### DETAILED DESCRIPTION OF THE INVENTION

The detailed description, as set forth below in connection with the appended drawings, is intended as a description of the presently preferred embodiments of the invention, and is not intended to represent the only form in which the present invention may be constructed or utilized.

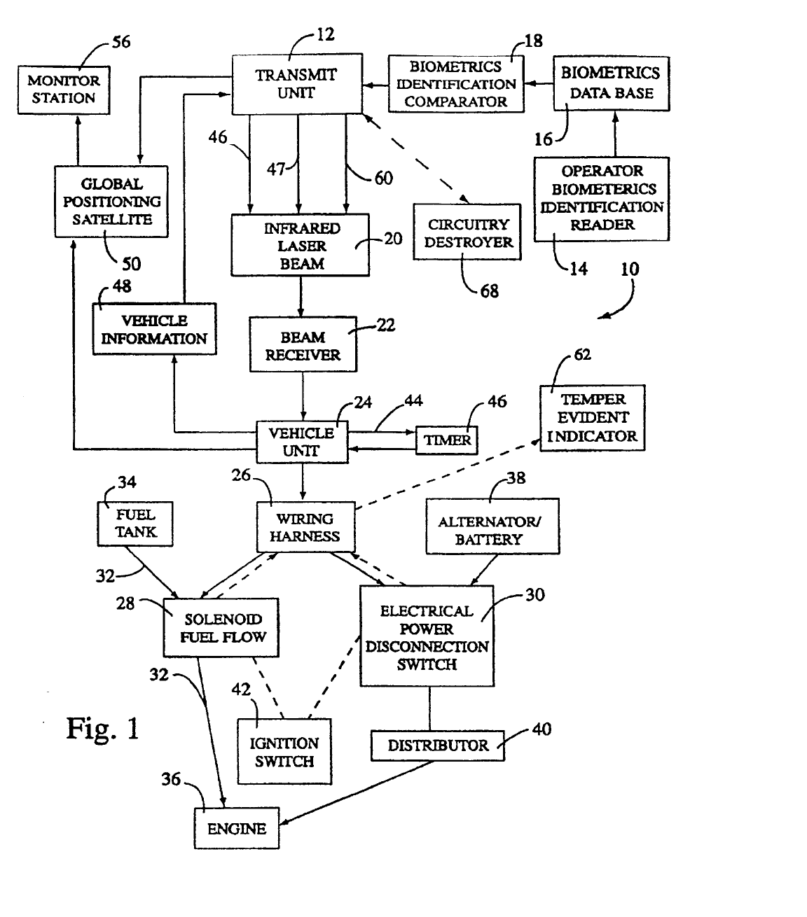

Referring now to the drawings wherein the showings are for the purposes of illustrating preferred embodiments of the present invention only, and not for the purposes of limiting the same, FIG. 1 illustrates a vehicle disabling system 10 operable only upon positive identification of an authorized operator. In particular, the system 10 has a preferably hand holdable transmit unit 12 including an operator biometrics identification reader 14, a data base 16 of stored authorized biometrics identifications, an identification comparator 18 for comparing and matching would-be operator biometrics identification with stored authorized biometrics identifications and for activating transmit unit operability upon a positive match, and a transmittable infrared laser beam 20. The preferred biometrics identification is a thumb print provided by the would-be operator to the reader 14. A preferred reader 14 is that available from Who Vision of Irvine, Calif., under the trademark TACTILESENSE. Once the thumb print is received, it is transferred to the data base 16 preferably situated within the transmit unit 12 and a conventional data base positive-match search of stored pre-authorized thumb prints occurs. Once a positive thumb print match within the data base 16 is achieved, which of course indicates that the would-be operator is authorized to operate the system 10, the transmit unit 12 becomes activated and is capable of transmitting the laser beam 20. As a further safeguard against unauthorized use of the transmit unit 12, the interior thereof can be provided with a circuitry destroyer 68 with circuit destruction capabilities. Such a destroyer 68 is non-limitedly exemplified in a recognized alliance of a capacitor and a strong-acid filled vial whose housing melts because of capacitor heating upon transmit-unit tampering that conventionally causes capacitor activation to thereby release the strong acid, which non-limitedly can be concentrated hydrochloric acid, sulfuric acid, nitric acid, or the like, which subsequently melts transmit-unit circuitry wiring.

Infrared laser beam transmittal is preferably in a relatively narrow width of about three feet over a distance of at least about one-half mile, and can be achieved by conventionally available transmitters such as that manufactured by Laser Technology, Inc., Englewood, Colo., Model LTI 20-20. Mounted at a preferably plurality of exterior sites of a vehicle are respective beam receivers 22 to which the laser beam 20 can be aimed. Vehicle placement of beam receivers 22 is relatively unlimited, and can include window sites, roof and body panel sites, lights, etc., with the primary objective for receiver placement being to assure a choice of several laser beam targets with which the transmit unit 12 can be associatedly aimed. As is known in the art, such receivers 22 can be relatively small and generally non-obtrusive. The receivers 22 are in conventional communication with a vehicle unit 24 disposed within the vehicle and preferably relatively hidden or otherwise not easily accessible to thereby deter attempted tampering. The vehicle unit 24 is in communication via a wiring harness 26 with both a closable solenoid fuel flow valve 28 and an electrical power disconnection switch 30, both as known in the art. The valve 28 is situated in a fuel line 32 leading from a fuel tank 34 to the vehicle engine 36, and preferably has a reset button located someplace within the vehicle such as in the trunk compartment. The vehicle unit 24 also preferably has an integral reset circuit 44 leading to a conventional timer 46 to thereby automatically reset and thus deactivate shutdown after a preset time as, for example, 20 minutes. The power disconnection switch 30 is disposed between the power source 38, generally an alternator and battery, and a conventional distributor 40 found in most engines. While the preferred embodiment includes a connection from the vehicle unit 24 to both a fuel flow valve 28 and a power disconnection switch 30, it is not necessary to have or include both of these operational components. Instead, only one or the other of the valve 28 and switch 30 can be in communication with the vehicle unit 24. Further, in a retrofit situation where a vehicle owner wishes to add the disabling system, addition of a fuel flow valve 28 is relatively easily performed. A tamper-evident indicator 62 can be provided in communication with the valve 28 and switch 30 via the harness 26. The indicator 62 can be, for example, a white or colored light on the exterior of the vehicle, and could even be a pre-existing back-up light, that remains illuminated to thereby draw attention to an unusual event. If attempted or actual disengagement of the valve 28 or switch 30 occurs, the indicator is permanently activated to thereby alert passers-by as well as law enforcement personnel of the presence of tampering and a probable security breach. In addition to being in communication with the vehicle unit 24, the valve 28 and switch 30 can be in communication with the keyed ignition switch 42 of the vehicle. A key (not shown) having a computer chip therewith is provided to complete a circuit as known in the art such that absence of a key results in a shut down of both the valve 28 and switch 30. When such communication is provided, the disabling system 10 additionally functions as an anti-theft system.

The transmit unit 12 and vehicle unit 24 can be provided with standard handshake encoding. In particular, the encoding system is constructed with circuitry as known in the art to provide a continuously changing coded key common to both the transmit unit 12 and the vehicle unit 24. This code is determined by time of day and an algorithm substantially identically operable in both the transmit unit 12 and the vehicle unit 24, with the time of day acceptable range being plus or minus one hour to thereby compensate for expected non-exact time settings. The transmit unit 12 transmits an encoded query message 46 to which the vehicle unit 24 responds with an encoded stream of vehicle identification information 48 which can include the vehicle identification number, vehicle owner identity, and the like. Depending upon the degree of present technology incorporated into the vehicle unit 24, the unit 24 can additionally relate earlier-loaded information, which can be remotely loaded by telephone connection thereto, concerning insurance coverage, previous vehicle-owner offenses, and the like. This information can be transmitted by radio signal from the vehicle unit 24 within which it is stored for such transmittal to the transmit unit 12 which is, of course, capable of receiving such radio signals in a conventional manner as known in the art. Upon receipt of the transmitted information, the operator of the transmit unit 12 can send a shutdown message 47 to the vehicle unit 24 as appropriate. Message transmission from the transmit unit 12 is vehicle specific, meaning that one transmit-unit activation can disable only one vehicle as opposed to a plurality of vehicles at once. Thus, a separate activation is required for each disablement. On the unlikely chance that an incorrect vehicle is accidently disabled because of mis-aiming or otherwise, the transmit unit 12 is provided with the capability to transmit a reset message 60 to the vehicle unit 24 of such incorrect vehicle to thereby re-establish vehicle operation.

The vehicle disabling system 10 additionally includes communication capabilities through a global positioning satellite 50 leading to a monitor station 56. Both the transmit unit 12 and the vehicle unit 24 preferably are in separate communication with the global positioning satellite. with respect to the transmit unit 12, such satellite communication functions to record all transmit unit usage and send this information to the monitor station 56 to thereby maintain and assure proper and appropriate operator use of the transmit unit 12. With respect to the vehicle unit 24, such satellite communication functions to receive and convey location information of the vehicle both for apprehension purposes and for stolen-vehicle recovery purposes.

Operability of the vehicle disabling system 10 is initiated when an operator places his thumb on the biometrics identification reader 14 and operator authorization is thereafter established as described above. Once the transmit unit 12 is so activated, the operator aims the transmit unit 12 such that the laser beam 14 strikes a beam receiver 22 to thereby deliver a query message to the vehicle unit 24 of a subject vehicle and establishes a handshake there between. Depending upon the response message from the vehicle unit 24 and the purpose of the query, the operator has a choice of proceeding no further (e.g. if ownership, insurance information, etc. is proper and no other action is indicated), or of sending a shutdown message and disabling the vehicle as described above.

As is thus apparent, the present invention provides a vehicle apprehension and recovery method that is effective without requiring substantial risk because of high speed or otherwise dangerous vehicular pursuits that are, in essence, stopped before they begin. Benefits inherent in the invention therefore include safety for persons in the proximity of an apprehension site, property preservation since destructive activity caused by speeding vehicles is precluded, and return of stolen vehicles to rightful owners without high repair expenses which are reflected in insurance costs. While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

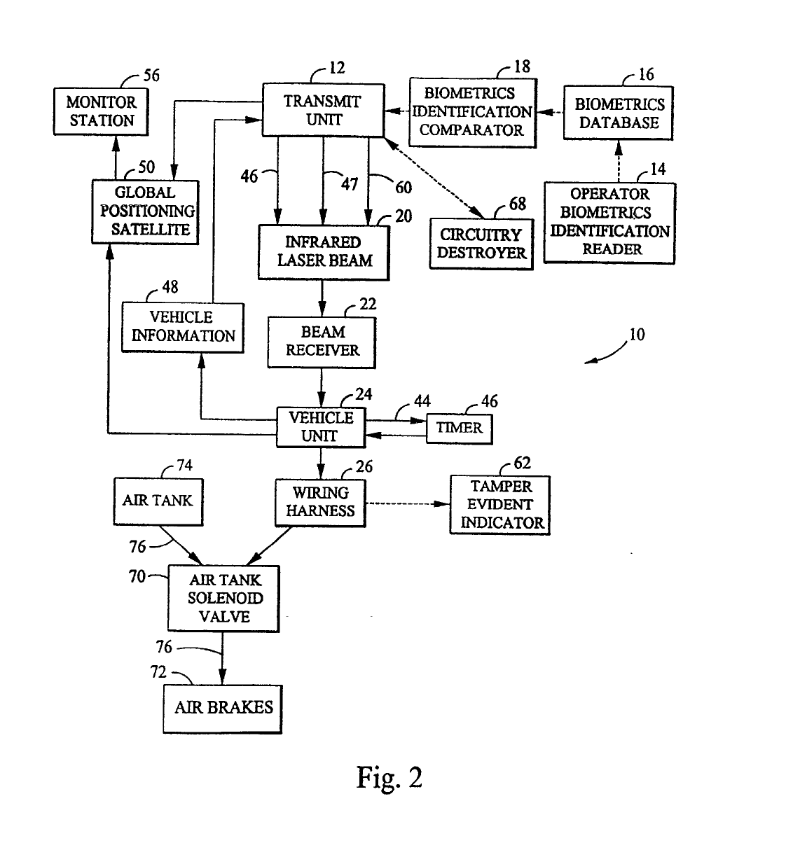

Referring now to FIG. 2, a vehicle disabling system 10 is illustrated which includes a transmit unit 12 transmitting at least one brake activation message 47 to the vehicle. The second embodiment is similar to the first embodiment in many aspects yet additionally addresses the need for disabling vehicle systems having brake systems, i.e. air brake systems. Preferably, the transmit unit 12 is hand holdable and additionally transmits signals via an infrared laser beam 20. The transmit unit transmits a reset message 60 as well when the vehicle unit 24 is equipped with a timer 46. The timer 46 and the reset message 60 allow the transmit unit 12 operator to re-establish vehicle operation in the unlikely event that the vehicle has been incorrectly disabled.

The vehicle may be a standard passenger vehicle. Preferably, the vehicle is a truck, tractor-trailer or bus having a braking system thereon. While some of these vehicles may be equipped with fluidic pressure braking systems, the present invention may equally be used to disable braking systems where air brakes are employed and others which may use comparable types of braking systems which are capable of being remotely activated or at least retrofitted to be remotely activated, i.e. anti-lock braking systems.

A vehicle unit 24 may be provided which is in communication with at least one braking component of the braking system such that receipt of the at least one brake activation message 47 causes the vehicle unit 24 to activate the at least one braking component thereby reducing speed of the vehicle and preventing movement thereof. Preferably, a plurality of air brakes 72 which are in communication with the at least one braking component. Each of the air brakes 72 may be disposed at respective locations on the vehicle for reducing speed thereof. The air brakes 72 are preferably disposed at locations on the vehicle such as the rotors, wheels, or other components which are engageable to reduce speed of the vehicle. Even more preferably, each of the air brakes 72 further include a respective spring brake connected thereto. Each spring brake is maintained in a non-engaging position allowing operation of the vehicle and is further positioned into an engaging position when the vehicle unit 24 receives the at least one brake activation message 47. As one skilled in the art will appreciate, spring brakes are defaulted in the non-engaging position at locations of vehicles where reduction of speed may be facilitated, i.e. rotors. The spring brake may be pressurized with all air tank to retain the spring brake in the non-engaging position. Should the air pressure being provided to the spring brake ever drop below a threshold level, the spring brake may automatically position itself into the engaging position such that the spring brake may contact the rotors, or other components of the vehicle, and reduce speed thereof In conjunction with the spring brake systems employed by such vehicles, the present system 10 may interface with at least one braking component to actuate the spring brakes. Preferably, the braking component is an air tank solenoid valve 70 placed inline between the air brakes 70 and/or spring brakes and an air tank 74. Thus, by providing a system 10 which may receive brake activation messages 47 from the transmit unit 12, the spring brakes may be actuated remotely by an operator to reduce the speed of the vehicle and eventually prevent movement of the vehicle.

To effectively retain the spring brakes in the non-engaging position, a constant air pressure may be provided to the spring brakes. Such air pressure may be delivered by an air tank 74 which in turn may be maintained to a constant air pressure via the use of an air compressor. In this respect, an air tank solenoid valve 70 may be provided which is communication with the air brakes 72. Preferably, the air tank solenoid valve 70 is in gaseous communication with the air brakes 72 and the air tank 74. The air tank solenoid valve 70 is positionable between an activated position and a deactivated position for selectively controlling activation and deactivation of the air brakes 72 respectively. Thus, the air tank solenoid valve 70 may remain open in the deactivated position to allow the air tank 74 to provide air pressure to the air brakes 72 and may alternatively close to the activated position to prevent the air tank 74 from pressurizing the air brakes 72. In conventional air brake systems where the air brakes are selectively pressurized by the air tank 74 to reduce speed, the air tank solenoid valve 70 may then be placed inline between the air tank 74 and the air brakes 72 to transition from a deactivated position maintaining the air tank solenoid valve 70 closed and transitioning to the activated position whereby the valve 70 is opened up. In this respect, the air tank solenoid valve 70 may effectively pressurize the air brakes 72 in response to receiving the brake activation message 47. Thus, the present system 10 for disabling vehicles having braking systems contemplates use with spring brake systems and other air brake systems utilizing air pressurization for reducing the speed of the vehicle.

It is also contemplated that the air tank 74 may be filled with a quantity of gas, i.e. air, which may be pressurized to provide sufficient force to the air brakes 72 for reducing the speed of the vehicle. Additionally, to allow the vehicle unit 24 to communicate with the air tank solenoid valve 70, the vehicle unit 24 may be placed into electrical communication with the air tank solenoid valve 70. In this respect, the air tank solenoid valve 70 is preferably capable of responding to electrical signals to transition between the activated and deactivated positions, i.e. closed and open.

Preferably, the air tank solenoid valve 70 is placed into such electrical communication with the vehicle unit 24 via a wiring harness 26. Advantageously, the wiring harness 26 may further be placed in electrical communication with a tamper evident indicator 62 as previously described herein. The tamper evident indicator 62 may serve to alert law enforcement officers and other civilians that the system 10 has been tampered with. In this respect, the tamper evident indicator 62 operates to anticipate potential tampering and alert others of the tampering so as to identify potentially suspicious activity. At the same time, the tamper evident indicator 62 may be placed in a location of the vehicle so as to conceal the operation of the tamper evident indicator 62 such that the operator of the vehicle may not be alerted to the tamper evident indicator 62 being employed. For example, the tamper evident indicator 62 may be formed as a reverse light or as another type of visually observable indicator, i.e. a stop light, a dedicated light. Alternatively, the tamper evident indicator 62 may operate to store a record in the vehicle unit 24 thereby allowing third parties to monitor proper operation of the system 10 and to be alerted by tampering of the same.

Additionally, the transmit unit 12 may include an infrared laser beam transmitter 20 for transmitting the at least one brake activation message 47 to at least a portion of the vehicle unit 24. Similarly, the vehicle unit 24 may include an infrared laser beam receiver 22 for receiving the at least one brake activation message 47 from the transmit unit 12. In this respect, such communications between the transmit unit 12 and the vehicle unit 24 may be conducted using infrared protocols.

In a third embodiment of the present invention, a vehicle disabling is provided which is substantially the same as the first and second embodiments yet is designed to be integrated into vehicles having anti-lock braking systems thereon. More specifically, anti-lock braking systems already include an electronic control unit which controls a hydraulic control unit. It has been discovered that by placing the vehicle unit 24 in communication with the electronic control unit via the wiring harness 26, upon receipt of at least one brake activation message 47, the vehicle unit 24 may activate the electronic control unit so as to facilitate activation of the respective anti-lock brakes on the vehicle. More specifically, the electronic control unit is typically in communication with a hydraulic control unit which modulates the anti-lock brakes on the vehicle to prevent loss of traction. By activating the electronic control unit, the transmission of the at least one brake activation message 47 may ultimately activate the existing anti-lock braking system to safely reduce speed of the vehicle without loss of traction or sliding and prevent further operation of the same. Optionally, a hydraulic solenoid valve may be provided instead of the air tank solenoid valve 70. The hydraulic solenoid valve, like the air tank solenoid valve 70, may be positionable between an activated position and a deactivated position for selectively controlling activation and deactivation of the anti-lock brakes. Thus, for example, receipt of the at least one brake activation message 47 may trigger the hydraulic solenoid valve and facilitate application of the anti-lock brakes by substantially opening the valve thereby permitting the flow of brake fluid to the anti-lock brakes. Thus, the present system is intended to operate in conjunction with existing braking systems, including air brakes and anti-lock brakes, and those which may later be developed.

Additional modifications and improvements of the present invention may also be apparent to those of ordinary skill in the art. Thus, the particular combination of parts described and illustrated herein is not intended to serve as limitations of alternative devices within the spirit and scope of the invention.

What is claimed is:

1. A vehicle disabling system for terminating operation of a vehicle having a braking system thereon, the system comprising:
a) a transmit unit transmitting at least one brake activation message to the vehicle; and
b) a vehicle unit in communication with at least one braking component of the braking system such that receipt of the at least one brake activation message causes the vehicle unit to activate the at least one braking component thereby reducing speed of the vehicle and preventing movement thereof.

2. The system as in claim 1 wherein the braking system further includes a plurality of air brakes in communication with the at least one braking component, each of the air brakes being disposed at respective locations on the vehicle for reducing speed thereof.

3. The system as in claim 2 wherein each of the air brakes further include a respective spring brake connected thereto, each spring brake being maintained in a non-engaging position allowing operation of the vehicle and further being positioned into an engaging position when the vehicle unit receives the at least one brake activation message.

4. The system as in claim 3 wherein each spring brake is provided with a constant air pressure for maintaining the spring brake in the non-engaging position and the spring brake is positioned into the engaging position by decreasing air pressure thereto.

5. The system as in claim 2 wherein the at least one braking component is an air tank solenoid valve in communication with the plurality of air brakes, the air tank solenoid valve being positionable between an activated position and a deactivated position for selectively controlling activation and deactivation of the air brakes respectively.

6. The system as in claim 5 wherein the air tank solenoid valve is in gaseous communication with each of the air brakes and an air tank having a quantity of gas stored therein.

7. The system as in claim 6 wherein the air tank solenoid valve in the activated position restricts flow of the gas from the air tank to air brakes while the air tank solenoid valve in the deactivated position allows flow of the gas from the air tank to the air brakes.

8. The system as in claim 6 wherein the gas is compressed air.

9. The system as in claim 6 wherein the air tank provides a constant air pressure to each of the air brakes when the air tank solenoid valve is in the deactivated position.

10. The system as in claim 1 wherein the air tank solenoid valve is in electrical communication with the vehicle unit.

11. The system as in claim 1 wherein the transmit unit further includes an infrared laser beam transmitter for transmitting the at least one brake activation message to at least a portion of the vehicle unit.

12. The system as in claim 11 wherein the vehicle unit further includes an infrared laser beam receiver for receiving the at least one brake activation message from the transmit unit.

13. The system as in claim 1 wherein the at least one braking component is in communication with a visually observable tamper-evident indicator disposed at an external site of the vehicle whereby tampering with the at least one braking component activates the indicator.

14. The system as in claim 1 wherein the system further comprises a communication linkage communicable with a global positioning satellite for sending a usage record of the transmit unit, the system further comprising and a remote receiver in communication with the global positioning satellite for receiving said usage record.

15. The system as in claim 1 wherein the transmit unit thereof additionally comprises a circuitry destroyer for destroying operational circuitry within the transmit unit and activateable upon attempted tampering with said circuitry.

16. The system as in claim 1 wherein the transmit unit transmits a vehicle identification query message and the vehicle unit transmits a query message response activated and generated solely by the vehicle unit.

17. The system as in claim 16 wherein transmissions and responses between the transmit unit and the vehicle unit are encoded with a continuously changing key determined by time of day and an algorithm common to the query message, the at least one brake activation message and the query message response.

18. The system as in claim 1 wherein the transmit unit thereof additionally comprises a reset message transmittable to the vehicle unit for reversal of a pre-transmitted brake activation message.

19. The system as in claim 1 wherein the transmit unit is handheld.

20. The system as in claim 1 wherein the braking system further includes a plurality of anti-lock brakes in communication with the at least one braking component, each of the anti-lock brakes being disposed at respective locations on the vehicle for reducing speed thereof.

21. The system as in claim 20 wherein the at least one braking component is an anti-lock braking system electronic control unit in communication with the plurality of anti-lock brakes.

22. A vehicle disabling system for terminating operation of a vehicle having a braking system thereon, the system comprising:
a) a transmit unit operable only by an operator having a pre-authorized biometrics identification for transmitting at least one brake activation message to the vehicle, the transmit unit additionally comprising an operator biometrics identifier having access to a data base of respective authorized biometrics stored-identification indicia for a plurality of respective authorized operators, a reader of operator biometrics indicia provided by the operator, a comparator of operator biometrics identification indicia with the stored-identification indicia for matching the operator biometrics identification indicia with the stored-identification indicia, and a transmit unit activator for activating the transmit unit only upon a match of operator biometrics identification indicia with stored-identification indicia; and
b) a vehicle unit for receiving the at least one brake activation message, with the vehicle unit being in communication with at least one braking component of the braking system such that receipt of the at least one brake activation message causes the vehicle unit to activate the at least one braking component thereby reducing speed of the vehicle and terminating operation thereof.

23. The system as in claim 22 wherein the braking system further includes a plurality of air brakes in communication with the at least one braking component, each of the air brakes being disposed at respective locations on the vehicle for reducing speed thereof.

24. The system as in claim 23 wherein each of the air brakes further include a respective spring brake connected thereto, each spring brake being maintained in a non-engaging position allowing operation of the vehicle and further being positioned into an engaging position when the vehicle unit receives the at least one brake activation message.

25. The system as in claim 24 wherein each spring brake is provided with a constant air pressure for maintaining the spring brake in the non-engaging position and the spring brake is positioned into the engaging position by decreasing air pressure thereto.

26. The system as in claim 23 wherein the at least one braking component is an air tank solenoid valve in communication with the plurality of air brakes, the air tank solenoid valve being positionable between an activated position and a deactivated position for selectively controlling activation and deactivation of the air brakes respectively.

27. The system as in claim 26 wherein the air tank solenoid valve is in gaseous communication with each of the air brakes and an air tank having a quantity of gas stored therein.

28. The system as in claim 27 wherein the air tank solenoid valve in the activated position restricts flow of the gas from the air tank to air brakes while the air tank solenoid valve in the deactivated position allows flow of the gas from the air tank to the air brakes.

29. The system as in claim 27 wherein the gas is compressed air.

30. The system as in claim 27 wherein the air tank provides a constant air pressure to each of the air brakes when the air tank solenoid valve is in the deactivated position.

31. The system as in claim 1 wherein the air tank solenoid valve is in electrical communication with the vehicle unit.

32. The system as in claim 1 wherein the transmit unit further includes an infrared laser beam transmitter for transmitting the at least one brake activation message to at least a portion of the vehicle unit.

33. The system as in claim 32 wherein the vehicle unit further includes an infrared laser beam receiver for receiving the at least one brake activation message from the transmit unit.

34. The system as in claim 1 wherein the at least one braking component is in communication with a visually observable tamper-evident indicator disposed at an external site of the vehicle whereby tampering with the at least one braking component activates the indicator.

35. The system as in claim 1 wherein the system further comprises a communication linkage communicable with a global positioning satellite for sending a usage record of the transmit unit, the system further comprising a remote receiver in communication with the global positioning satellite for receiving said usage record.

36. The system as in claim 1 wherein the transmit unit thereof additionally comprises a circuitry destroyer for destroying operational circuitry within the transmit unit and activateable upon attempted tampering with said circuitry.

37. The system as in claim 1 wherein the transmit unit transmits a vehicle identification query message and the vehicle unit transmits a query message response activated and generated solely by the vehicle unit.

38. The system as in claim 16 wherein transmissions and responses between the transmit unit and the vehicle unit are encoded with a continuously changing key determined by time of day and an algorithm common to the query message, the at least one brake activation message and the query message response.

39. The system as in claim 1 wherein the transmit unit thereof additionally comprises a reset message transmittable to the vehicle unit for reversal of a pre-transmitted brake activation message.

40. The system as in claim 1 wherein the transmit unit is handheld.

41. A method of disabling a vehicle having a braking system thereon, the method comprising the steps of:
a) providing a transmit unit;
b) transmitting at least one brake activation message to the vehicle via the transmit unit;
c) providing a vehicle unit in communication with at least one braking component of the braking system;
d) activating the at least one braking component in response to receiving the at least one brake activation message; and
e) reducing speed of the vehicle and preventing movement thereof.
